(19) United States
(12) Patent Application Publication
(10) Pub. No.: US 2026/0338732 A1
(43) Pub. Date: Oct. 29, 2026

(54) METHODS OF MEASURING ELECTRODE SELECTIVITY

(71) Applicant: The Regents of the University of California, Oakland, CA (US)

(72) Inventors: Xin Chen, Los Angeles, CA (US); Gaurav Sant, Los Angeles, CA (US); David Jassby, Los Angeles, CA (US)

(21) Appl. No.: 19/655,993

(22) Filed: Apr. 23, 2026

Related U.S. Application Data
(60) Provisional application No. 63/794,792, filed on Apr. 25, 2025.

(51) Int. Cl. G01N 27/49; G01N 27/333

(52) U.S. Cl. CPC G01N 27/49; G01N 27/333

(57) ABSTRACT

Provided herein are non-destructive methods of determining electrode selectivity.

### CROSS-REFERENCE TO RELATED APPLICATIONS

This application claims the benefit of priority to U.S. Provisional Patent Application No. 63/794,792, filed Apr. 25, 2025, the entire contents of which are incorporated by reference herein.

### STATEMENT OF GOVERNMENT SUPPORT

This invention was made with government support under DE-AR0001551 awarded by the U.S. Department of Energy. The government has certain rights in the invention.

### BACKGROUND

Electrochemical selectivity of an electrode is a key performance indicator and determines electrolyzer performances. For instance, in a seawater electrolyzer, an anode's selectivity between chlorine evolution reactions (CIER; 2Cl⁻=Cl₂+2e⁻) and oxygen evolution reactions (OER; 2H₂O=4H⁺+O₂+4e⁻ or 4OH=2H₂O+O₂+4e⁻) is important for the longevity of the electrolyzer components due to the detrimental nature of free-chlorine species (e.g., Cl₂, HClO, ClO⁻) on system components. However, electrode selectivity is usually revealed only after the electrolyzer is assembled and running, often too late if the electrode is defective or damaged because 1) failure analysis of a stack of electrodes can be tedious and time-consuming, and 2) disassembling the electrolyzer stack can cause irreversible damages to stack components including the electrodes. In addition, non-destructively examining large-sized electrodes over the entire surfaces is challenging. Accordingly, there exists a need for expedient and non-destructive methods of determining anode oxygen selectivity.

### SUMMARY OF THE INVENTION

In certain aspects, provided herein are methods for measuring the selectivity of an electrode in an electrochemical cell. The cell may comprise a working electrode chamber flanked by two counter electrode chambers, each containing a counter electrode, electrolyte feed inlet, and gas outlet. The working electrode chamber and counter electrode chambers are separated by separators and are in ionic communication. In certain embodiments, the method involves contacting the feed inlets with an electrolyte solution comprising an electroactive species, measuring an initial concentration of a product species in the working electrode chamber, applying a constant electric potential across the working electrode, the first counter electrode, and the second counter electrode, thereby converting the electroactive species to a product species in the working electrode chamber, and comparing the final concentration of the product species in the working electrode chamber to the initial concentration of the product species in the working electrode chamber, thereby determining the selectivity of the working electrode. The electrolyte solution may further comprise a buffer, such as borate, phosphate buffer solutions, or any other known electrochemically stable pH buffer. The method may be applied to various electroactive species such as Cl⁻, H₂O, or OH, with corresponding product species Cl₂, H⁺, O₂, ClO⁻, and/or HClO. Other suitable electroactive species will be apparent to those of ordinary skill in the art. Suitable working electrodes for use with the methods provided herein will also be apparent to those of ordinary skill in the art, and may comprise, for example, Mn, Ir, Co, Ru, Sn, Ni, Pt, Ta, Fe, W or Mo, or a combination thereof. In certain preferred embodiments, the methods provided herein are non-destructive with respect to the working electrode, and may be carried out without disassembling the electrochemical cell.

In certain embodiments, dyes or color tracers sensitive to the electrolytic products may be added to the working electrode cell to identify any regions of potential damage. For instance, dyes or color tracers may be to the working electrode cell and visually inspected for signs of bleaching. Bleaching spots may imply that those regions include a defective oxygen-selective coating. Suitable dyes and color tracers for use with the methods provided herein will be apparent to those of ordinary skill in the art.

### BRIEF DESCRIPTION OF THE DRAWINGS

FIG. 1A is a top-down schematic representation of a representative system used to check the CIER selectivity of exemplary oxygen-selective anodes.

FIG. 1B shows an image of a diaphragm comprising alumina suitable for use in the methods of the present disclosure.

FIG. 1C shows a schematic of a cathode suitable for use in the methods of the present disclosure.

FIG. 2 is a plot comparing CIER selectivity measured by an exemplary method of the disclosure (batch-CIER), and the reported CIER selectivity determined in a flow though electrolyzer with a seawater feed (flow though-CIER).

FIG. 3 is a plot comparing CIER selectivity measured by an exemplary method of the disclosure (batch-CIER), as measure with varying NaHCO₃ buffer concentrations.

### DETAILED DESCRIPTION OF THE INVENTION

Provided herein are methods to rapidly examine an electrode's selectivity using an electrolyzer comprising 1) a working electrode (the electrode which is to be tested), 2) a counter electrode, 3) an electrolyte, and 4) a separator that prevents fast exchange of the electrolyte. The electrolyte comprises at least one electroactive species that is suitable to reveal the selectivity of the electrode (for example, Cl⁻ ions, if CIER selectivity is to be measured). Once a current is passing through the electrodes, the electroactive species undergoes redox reactions at the working electrode, and the concentration of the electrolytic products can be determined in the electrolyte and then converted to selectivity using means known to those of skill in the art (see Example 1 for an exemplary calculation of CIER selectivity). The separator may comprise a membrane (e.g., an anion exchange membrane or a cation exchange membranes) or a diaphragm which comprises porous media that allow solution to pass slowly but not convectively, e.g., porous ceramics such as alumina, zirconia, clay, asbestos, etc., or porous polymers such as PTFE, PVDF, PE, PP, etc. The separator is preferably suitable to preserve electrolytic products within the working electrode compartment and to prevent migration of electrolytic products into the counter electrode compartment during the testing period. The counter electrode serves as a current collector and comprises materials that are stable in the electrolyte.

In certain embodiments, electrode selectivity is determined using Equation 1:

$$S = \frac{2 * F * Δ {C}_{C l 2} * V}{1000 * {M}_{C l 2} * t * I} * 100 \% = 2.718 * \frac{Δ {C}_{C l 2} * V}{t * I} * 100 \% \qquad ( 1 )$$

wherein S is the working electrode selectivity (in %), F is Faraday constant (96485 C/mol), ΔC_{Cl2} is a difference between the initial concentration and the final concentration of Cl₂ (in ppm or mg/L), V is a volume of solution in the working electrode chamber (in L), M_{Cl2} is the molar mass of Cl₂ (71 g/mol), t is the time period that the electric potential was applied (in seconds), and I is a current applied across the working electrode, the first counter electrode, and the second counter electrode (in A).

Suitable working electrodes for use with the methods provided herein will be apparent to those of ordinary skill in the art, and may be found in, for example, U.S. Pat. No. 12,247,303, the entire contents of which are incorporated by reference herein.

In certain aspects, provided herein are methods for measuring a selectivity of a working electrode, comprising:
contacting a first electrolyte feed inlet, a second electrolyte feed inlet, and a third electrolyte feed inlet of an electrochemical cell with an electrolyte solution comprising an electroactive species;
   wherein the electrochemical cell comprises:
      a first counter electrode chamber comprising:
         a first counter electrode;
         the first electrolyte feed inlet; and
         a first gas outlet;
      a second counter electrode chamber comprising:
         a second counter electrode;
         the second electrolyte feed inlet; and
         a second gas outlet;
      a working electrode chamber comprising:
         the working electrode;
         a third electrolyte feed inlet; and
         a third gas outlet;
      a first separator disposed between the first counter electrode chamber and the working electrode chamber; and
      a second separator disposed between the second counter electrode chamber and the working electrode chamber;
      wherein:
      the working electrode chamber is disposed between the first counter electrode chamber and the second counter electrode chamber and oriented such that the working electrode is disposed between and parallel to the first counter electrode and the second counter electrode;
      the working electrode, the first counter electrode, and the second counter electrode are electrically connected; and
      the first counter electrode chamber, the second counter electrode chamber, and the working electrode chamber are in ionic communication;
measuring an initial concentration of a product species in the working electrode chamber;
applying a constant electric potential across the working electrode, the first counter electrode, and the second counter electrode, thereby converting the electroactive species to a product species in the working electrode chamber; and
measuring a final concentration of the product species in the working electrode chamber; and
comparing the final concentration of the product species in the working electrode chamber to the initial concentration of the product species in the working electrode chamber, thereby determining the selectivity of the working electrode.

In certain embodiments, the constant electric potential is applied across the working electrode, the first counter electrode, and the second counter electrode for a time period of about 1 second(s) to about 10 min. In further embodiments, the time period is about 30 s to about 90 s.

In some embodiments, the electroactive species is Cl⁻. In further embodiments, the electroactive species is Cl⁻, and the product species comprises Cl₂, ClO⁻, or HClO. In further embodiments, the electroactive species is Cl⁻, and the product species is Cl₂, ClO⁻, or HClO. In certain embodiments, the electroactive species is Cl⁻, and the product species is Cl₂. In some embodiments, the electroactive species is Cl⁻, and the product species is Cl₂ and ClO⁻.

In certain embodiments, the electroactive species is H₂O. In further embodiments, the electroactive species is H₂O, and the product species is H⁺. In some embodiments, the electroactive species is H₂O, and the product species is H⁺, OH⁻, O₂, or H₂, or a combination thereof.

In some embodiments, the electroactive species is OH. In further embodiments, the electroactive species is OH, and the product species is O₂.

In certain embodiments, the electrolyte solution further comprises a buffer. In some such embodiments, the buffer maintains a pH greater than about 5 in the electrolyte solution, e.g., from about 5 to about 14. In certain such embodiments, maintaining a pH greater than about 5 inhibits or reduces production of Cl₂. In further embodiments, inhibiting or reducing production of Cl₂ comprises producing aqueous ClO⁻ instead of Cl₂. As will be appreciated by one of skill in the art, reducing Cl₂ production in the working electrode chamber offers certain process advantages such as increased equipment longevity and decreased corrosion of system components (e.g., in the working electrode chamber).

In certain embodiments, the buffer is NaHCO₃, borate, or phosphate buffer solutions, preferably NaHCO₃. In certain preferred embodiments, the buffer is a borate buffer solution. In further embodiments, the borate buffer solution comprises H₃BO₃, NaOH, NaCl, H⁺, H₂BO₃⁻, HBO₃²⁻, BO₃³⁻, Na⁺, OH⁻, Cl⁻, or a combination thereof.

In certain embodiments, the method further comprises adding a dye or color tracer to the electrochemical cell, wherein the dye or color tracer is sensitive to the product species. In some such embodiments, the dye or color tracer interacts chemically with the product species.

In some embodiments, the first counter electrode comprises a C276 alloy. In certain embodiments, the second counter electrode comprises a C276 alloy.

In certain embodiments, the working electrode comprises Mn. In some embodiments, the working electrode comprises Ir. In certain embodiments, the working electrode comprises Co. In some embodiments, the working electrode comprises Ru. In certain embodiments, the working electrode comprises Sn. In some embodiments, the working electrode comprises Ni. In certain embodiments, the working electrode comprises Mo. In some embodiments, the working electrode comprises Pt. In certain embodiments, the working electrode comprises Ta. In some embodiments, the working electrode comprises Fe. In certain embodiments, the working electrode comprises W.

In some embodiments, the first separator and the second separator comprise a membrane. In further embodiments, the first separator and the second separator comprise an anion exchange membrane or a cation exchange membrane. In certain embodiments, the first separator and the second separator comprise a porous ceramic. In further embodiments, the first separator and the second separator comprise alumina, zirconia, clay, or asbestos. In some embodiments, the first separator and the second separator comprise a porous polymer. In further embodiments, the first separator and the second separator comprise polytetrafluoroethylene, polyvinylidene difluoride, polyethylene, or polypropylene.

In certain preferred embodiments, the method does not comprise damaging the working electrode.

In some preferred embodiments, the method does not comprise damaging an outer surface of the working electrode.

In certain preferred embodiments, the method does not comprise disassembling the electrochemical cell.

In some preferred embodiments, the electrochemical cell is continuously operated throughout the entire duration of the method.

In certain preferred embodiments, the working electrode remains operable for converting the electroactive species to the product species throughout the duration of the method and thereafter.

In some preferred embodiments, an outer surface of the working electrode remains essentially intact following completion of the method.

### DEFINITIONS

Unless otherwise defined herein, scientific and technical terms used in this application shall have the meanings that are commonly understood by those of ordinary skill in the art. Generally, nomenclature used in connection with, and techniques of, chemistry, chemical engineering, electrical engineering and civil engineering described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

As used herein, the term “selectivity” refers to the degree to which a certain process or electrode favors the formation of a particular product over other products. As will be understood by a person of ordinary skill in the art, the selectivity may be a function of process steps, parameters, and conditions (e.g., temperature, reaction times, pre-treatment steps, etc.), and/or may be the result of intrinsic properties of system components (e.g., as a result of using electrodes that are selective for the formation of oxygen). A selectivity value may refer to a proportion of the product(s) of interest compared to other product(s) produced, or may refer to the proportion of other product(s) produced compared to the product(s) of interest. A person of ordinary skill in the art will appreciate how to select suitable methods for testing, calculating, and comparing selectivity values relevant to the present disclosure. For example, in certain embodiments, electrodes disclosed herein are at greater than 99% selective for Oxygen Evolution Reactions (OER) and less than 1% selective for Chlorine Evolution Reactions (CIER), while a platinum electrode used as a non-oxygen-selective benchmark exhibits a selectivity from about 20% to about 40% for OER and from about 60% to about 80% for CIER.

As used herein, the term “simulated seawater” is mixture of water and certain salts that mimics the composition of natural seawater (e.g., for use in testing electrodes disclosed herein). For example, “simulated seawater” as used herein may refer to a solution which meets the American Society for Testing and Materials (ASTM International) standard ASTM D1141-52, Formula a, Table 1, Section 4 and the updated Standard ASTM D1141-98 (2013) Formula a, Table x1.1, Section 6.

As used herein, the term “current density” refers to an amount of charge flowing per unit time (i.e., current) through a unit area. For example, current density may be expressed as current (e.g., in Amperes) flowing through a unit area (e.g., in m²) of the surface of an anode of the disclosure using the unit A/m². Those of skill in the art are familiar with means of measuring and adjusting current density in electrical circuits relevant to the present disclosure.

As used herein, the terms “semiconductive,” “electrically semiconductive,” “semiconductor,” and other grammatical variants thereof refer to any material having semiconductive properties, including, e.g., a non-zero band gap between the valence band and conduction band of the material, and/or an electrical conductivity that increases as temperature increases. Such materials include, as non-limiting examples: Si, SiC, SiGe, SiGeC, Si alloys, Ge, Ge alloys, GaAs, InAs, InP. “Doped” semiconductors, comprising both n- and p-type dopants are also expressly contemplated.

As used herein, the terms “conductive,” “electrically conductive,” and other grammatical variants thereof describe any electrically conductive material, e.g., metals, which have a high electrical conductivity and low electrical resistivity and which have properties common to conductors (e.g., an electrical conductivity that decreases as temperature increases). For example, a material described herein as “conductive” may comprise a material having an electrical conductivity of about 58 MS/m (the International Annealed Copper Standard).

The phrase “a combination thereof,” as used herein with reference to a list or group (e.g., “wherein the dopant is selected from Sn, Fe, W, In, F, Si, and a combination thereof”), expressly contemplates any combination of any number of the group members. For example, in certain embodiments of the present disclosure, “a combination thereof” is used in reference to the group Sn, Fe, W, In, F, and Si. In such embodiments, the present disclosure expressly contemplates each and every combination of any two elements, any three elements, any four elements, any five elements, and all six elements of the group, e.g., the combination of Sn and Fe (two elements), and the combination of Sn, Fe, W, In, F, and Si (all six elements).

### EXAMPLES

The invention now being generally described, it will be more readily understood by reference to the following examples which are included merely for purposes of illustration of certain aspects and embodiments of the present invention, and are not intended to limit the invention.

### Example 1: Exemplary Synthesis of Single-Layered Electrode

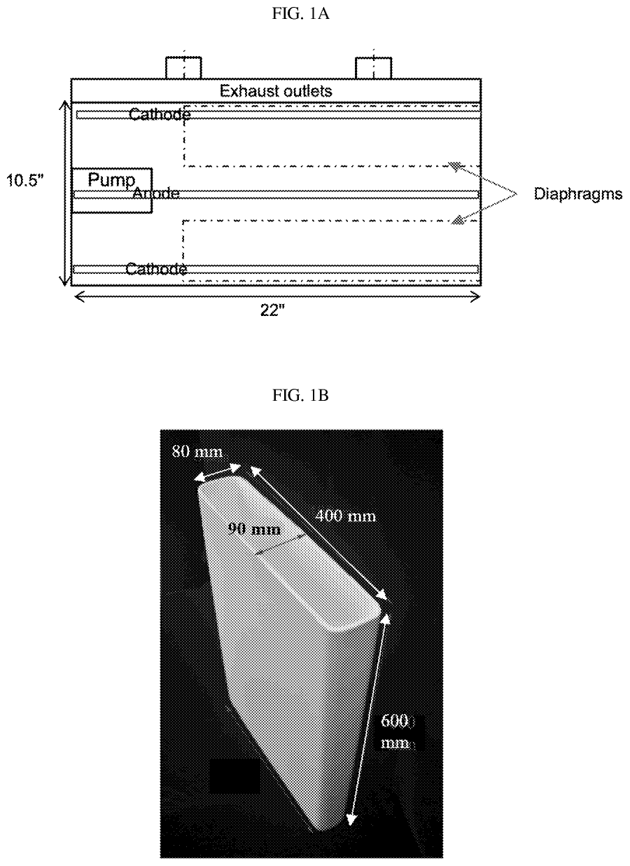

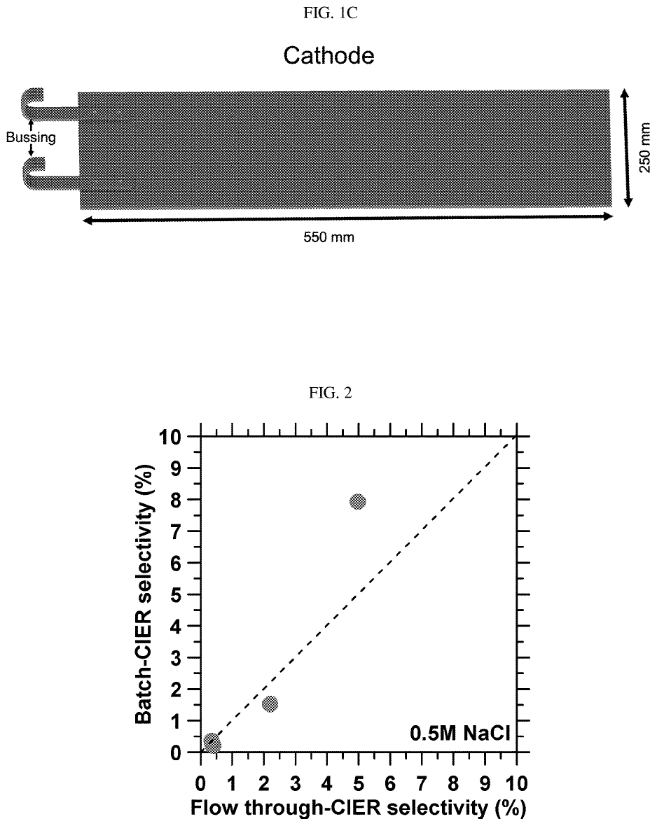

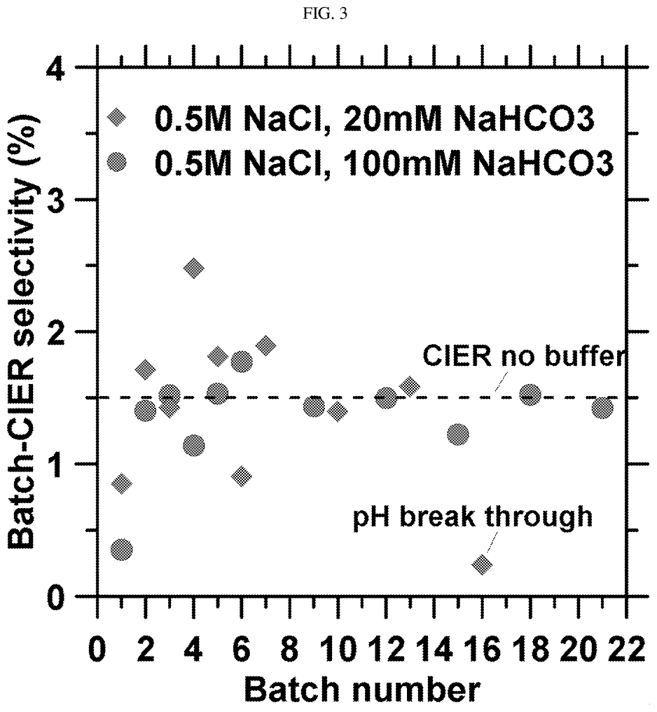

A system was designed to characterize the CIER selectivity of double-sided oxygen-selective anodes. As illustrated in FIG. 1, an electrolytic reactor was designed with the OSA at the center and two counter electrodes (cathodes) facing each side of the OSA's surfaces. The cathodes are made with C276 alloy and housed by two diaphragm vessels made with 5 mm thick, porous alumina. Both OSAs and cathodes were connected to a power supply via the bussing. The electrolyte filled both the anode and cathode compartments is a 0.5 M NaCl solution with the pH buffered by adding NaHCO₃. The OSA's selectivity was determined by passing a constant current for a short period of time (30 s to 90 s), and then measuring the free-chlorine concentration changed in the anode compartment. The detailed equation is as follows:

$$S = \frac{2 * F * Δ {C}_{C l 2} * V}{1000 * {M}_{C l 2} * t * I} * 100 \% = 2.718 * \frac{Δ {C}_{C l 2} * V}{t * I} * 100 \% \qquad Equation 1$$

where S is the CIER selectivity (in %), F is faraday constant (96485 C/mol), ΔC_{Cl2} is the increment of free-chlorine (in ppm or mg/L), V is the volume of solution added in the anode compartment (in L), M_{Cl2} is the molar mass of Cl₂ (71 g/mol), t is the time interval (90 s), and I is the current (in A). As indicated in FIG. 2, identical CIER selectivity were determined by the proposed system as compared to that measured with the flow through seawater electrolyzers, demonstrating the effectiveness and accuracy of the proposed approach. In addition, the concentration of NaHCO₃ buffer does not affecting the measured CIER selectivity, and more concentrated NaHCO₃ can prevent anolyte acidification, preventing Cl₂ gas evolution (i.e., via HClO+HCl=Cl₂+H₂O) and ensuring free-chlorine species are encapsulated in the solution (see FIG. 3).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method for measuring a selectivity of a working electrode, comprising:
contacting a first electrolyte feed inlet, a second electrolyte feed inlet, and a third electrolyte feed inlet of an electrochemical cell with an electrolyte solution comprising an electroactive species;
wherein the electrochemical cell comprises:
a first counter electrode chamber comprising:
a first counter electrode;
the first electrolyte feed inlet; and
a first gas outlet;
a second counter electrode chamber comprising:
a second counter electrode;
the second electrolyte feed inlet; and
a second gas outlet;
a working electrode chamber comprising:
the working electrode;
a third electrolyte feed inlet; and
a third gas outlet;
a first separator disposed between the first counter electrode chamber and the working electrode chamber; and
a second separator disposed between the second counter electrode chamber and the working electrode chamber;
wherein:
the working electrode chamber is disposed between the first counter electrode chamber and the second counter electrode chamber and oriented such that the working electrode is disposed between and parallel to the first counter electrode and the second counter electrode;
the working electrode, the first counter electrode, and the second counter electrode are electrically connected; and
the first counter electrode chamber, the second counter electrode chamber, and the working electrode chamber are in ionic communication;
measuring an initial concentration of a product species in the working electrode chamber;
applying a constant electric potential across the working electrode, the first counter electrode, and the second counter electrode, thereby converting the electroactive species to a product species in the working electrode chamber; and
measuring a final concentration of the product species in the working electrode chamber; and
comparing the final concentration of the product species in the working electrode chamber to the initial concentration of the product species in the working electrode chamber, thereby determining the selectivity of the working electrode.

2. The method of claim 1, wherein the constant electric potential is applied across the working electrode, the first counter electrode, and the second counter electrode for a time period of about 1 second(s) to about 10 min.

3. The method of claim 2, wherein the time period is about 30 s to about 90 s.

4. The method of claim 1, wherein the electroactive species is Cl.

5. The method of claim 1, wherein the electroactive species is Cl⁻, and the product species comprises Cl₂, ClO⁻, or HClO.

6. The method of claim 1, wherein the electroactive species is H₂O.

7. The method of claim 1, wherein the electroactive species is H₂O, and the product species is H⁺, OH⁻, O₂, or H₂, or a combination thereof.

8. The method of claim 1, wherein the electroactive species is OH.

9. The method of claim 1, wherein the electroactive species is OH, and the product species is O₂.

10. The method of claim 1, wherein the electrolyte solution further comprises a buffer.

11. The method of claim 10, wherein the buffer maintains a pH greater than about 5 in the electrolyte solution.

12. (canceled)

13. The method of claim 10, wherein the buffer is NaHCO₃, borate, or phosphate buffer solutions.

14. (canceled)

15. (canceled)

16. The method of claim 1, further comprising adding a dye or color tracer to the electrochemical cell, wherein the dye or color tracer is sensitive to the product species.

17. (canceled)

18. (canceled)

19. The method of claim 1, wherein the working electrode comprises Mn, Ir, Co, Ru, Sn, Ni, Mo, Pt, Ta, Fe, or W, or a combination thereof.

20-32. (canceled)

33. The method of claim 1, wherein the method does not comprise damaging the working electrode.

34. The method of claim 1, wherein the method does not comprise damaging an outer surface of the working electrode.

35. The method of claim 1, wherein the method does not comprise disassembling the electrochemical cell.

36. The method of claim 1, wherein the electrochemical cell is continuously operated throughout the entire duration of the method.

37. The method of claim 1, wherein the working electrode remains operable for converting the electroactive species to the product species throughout the duration of the method and thereafter.

38. The method of claim 1, wherein an outer surface of the working electrode remains essentially intact following completion of the method.
